(19) United States
(12) Patent Application Publication
(10) Pub. No.: US 2019/0135186 A1
(43) Pub. Date: May 9, 2019

(54) VEHICLE HUB STEP APPARATUS

(71) Applicant: Ford Global Technologies, LLC, Dearborn, MI (US)

(72) Inventors: Gregory Hagedorn, Bloomfield Hills, MI (US); Corbin Shea Johnston, Winnipeg (CA); Jimmy Moua, Canton, MI (US); Johnathan Andrew Line, Northville, MI (US)

(21) Appl. No.: 15/808,479

(22) Filed: Nov. 9, 2017

(51) Int. Cl. B60R 3/00; B60B 7/00; B60B 7/08

(52) U.S. Cl. CPC B60R 3/007; B60B 7/08; B60B 7/0066; B60B 7/0013

(57) ABSTRACT

Vehicle hub step apparatus are disclosed. An example wheel hub step includes a radially-symmetric body having a first end to be adjacent a vehicle wheel and a second end opposite the first end. Additionally, the wheel hub step includes a wall extending between the ends and approximately coaxial relative to a rotational axis of the vehicle wheel. The wall of the wheel hub step having an outer surface including a surface treatment to increase friction between footwear and the wheel hub step.

### FIELD OF THE DISCLOSURE

This disclosure relates generally to vehicle safety and accessibility accessories, and, more particularly, to vehicle hub step apparatus.

### BACKGROUND

Larger vehicles, such as trucks and sport utility vehicles (SUVs), are designed to operate in rugged work environments. Designing for a rugged work environment can include increased clearance height underneath the truck and SUV. In some examples, trucks and SUVs are used to transport large, heavy objects, which are typically transported on the roof of the SUV or in the bed of the truck.

### SUMMARY

An example wheel hub step includes a radially-symmetric body having a first end to be adjacent a vehicle wheel and a second end opposite the first end. The wheel hub step also includes a wall extending between the ends and is approximately coaxial relative to a rotational axis of the vehicle wheel. The wall has an outer surface including a surface treatment to increase friction between footwear and the wheel hub step.

Another example wheel hub step includes means for stepping including an outer surface. The outer surface includes a surface treatment to increase friction between footwear and the wheel hub step. The wheel hub step also includes means for coupling the means for stepping to a vehicle wheel.

Another example apparatus includes a radially-symmetric wheel hub step extending from a vehicle wheel. The wheel hub step extends approximately coaxial relative to a rotational axis of the vehicle wheel including a solid, textured surface.

### BRIEF DESCRIPTION OF THE DRAWINGS

FIG. 1 illustrates an example vehicle in which the examples disclosed herein may be implemented.

FIG. 2 illustrates an example wheel hub step integral with a wheel hub.

FIG. 3 illustrates an example wheel hub step including a snap-fit connector.

FIG. 4 illustrates an example wheel hub step including hub connectors.

FIG. 5 illustrates an example wheel hub step having a radially-symmetric body having a cylindrical shape.

FIG. 6 illustrates an example wheel hub step having a radially-symmetric body having a polygonal shape.

The figures are not to scale. Wherever possible, the same reference numbers will be used throughout the drawing(s) and accompanying written description to refer to the same or like parts. As used in this patent, stating that any part (e.g., a layer, film, area, or plate) is in any way positioned on (e.g., positioned on, located on, disposed on, or formed on, etc.) another part, indicates that the referenced part is either in contact with the other part, or that the referenced part is above the other part with one or more intermediate part(s) located therebetween. Stating that any part is in contact with another part means that there is no intermediate part between the two parts.

### DETAILED DESCRIPTION

Vehicle manufacturers design vehicles, such as trucks and sport utility vehicles (SUVs), to be driven off-road. Driving off-road requires increased undercarriage clearance height and taller wheels to avoid brush, debris, and/or contact with uneven portions of the driving surface. An increased clearance height can make some tasks such as accessing the engine compartment difficult. Additionally, trucks and SUVs are used to transport various materials. These materials, when disposed in the truck bed or on the roof of the vehicle, can be difficult to reach.

To access the engine compartment, the bed of a truck, or the roof of a vehicle, people may step on a tire or a box side step of the vehicle. In some examples, the tire can be slippery due to rain, snow, mud, ice, or other detritus. While the box side step is safer than stepping on the tire of a vehicle, it is an expensive addition to a vehicle, and may not provide access to the full length of a truck bed, and does not provide any access to a vehicle engine compartment.

In accordance with the present disclosure, a wheel hub step is included with the wheel of a vehicle to improve access to a truck bed, a vehicle roof, and an engine compartment. In some examples, the wheel hub step includes a surface treatment to an outer surface of a solid wall of the wheel hub step. The surface treatment on the outer surface increases friction between footwear and the wheel hub step to reduce slippage between the footwear and the wheel hub step. Additionally, a wall of the wheel hub step is approximately coaxial relative to a rotational axis of the vehicle wheel (e.g., ±3°, ±7°, etc. with respect to the rotational axis) and radially-symmetric so the wheel hub step can be used at any angular position. The wheel hub step is a means for stepping. In other examples, the means for stepping can include other wheel hub step surface treatments, can include different step body shapes, and/or the step can extend various distances from the hub of the vehicle wheel.

In some examples, the wheel hub step is integral with the vehicle wheel. In other examples, the wheel hub step includes means for coupling the wheel hub step to the wheel hub. For example, the means for coupling can include fastening the wheel hub step to the wheel hub via the bolts that secure the wheel to the vehicle. In other examples, means for coupling can also be snap-fit connectors, keyed slots, slip-fit friction protrusions, quick disconnects, etc. In accordance with the present disclosure, the means for coupling and the wheel hub step are capable of supporting the full weight of a person and the additional weight of an object the person is carrying.

The example wheel hub step apparatus described herein is an improvement over stepping on the tire of a vehicle. For example, the wheel hub step is at a more ergonomic height compared to the top of a truck tire. Additionally, the wheel hub step can include a cover over a set of wheel fasteners to prevent the set of wheel fasteners from corroding. Further, the wheel hub step is also less expensive and, in some examples, more useful than a box side step.

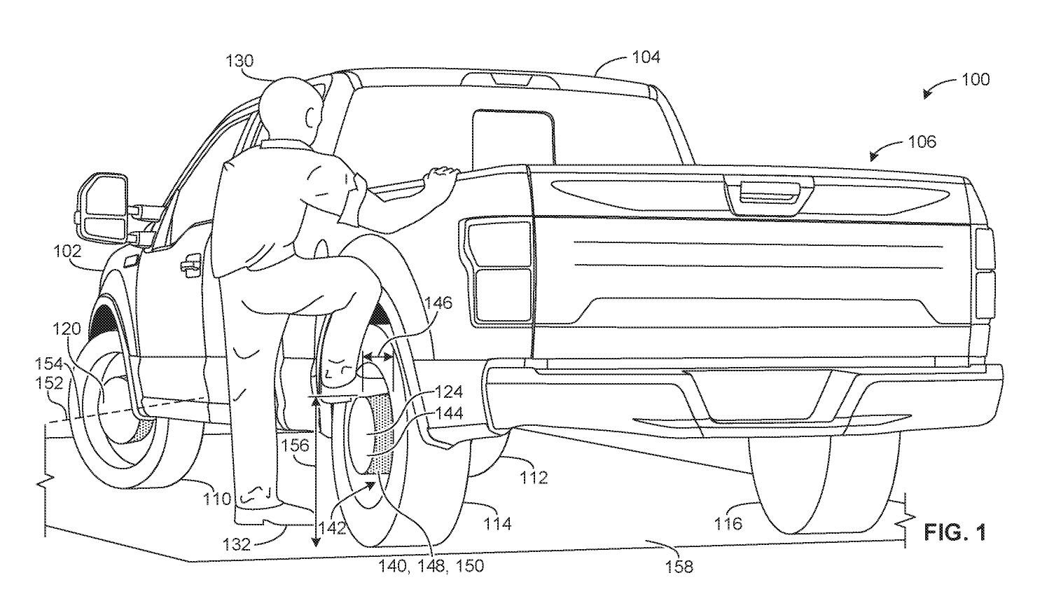

FIG. 1 illustrates an example vehicle 100 in which the examples disclosed herein may be implemented. In other examples, the vehicle 100 is an SUV or a cargo van. In the illustrated example, the vehicle 100 includes an engine compartment 102, a roof 104, and a truck bed 106. In some examples, the vehicle 100 may additionally include an overhead rack and/or a truck bed cap. The example vehicle 100 also includes a first front wheel 110, a second front wheel 112, a first rear wheel 114, and a second rear wheel 116. In the illustrated example, the first front wheel 110 includes a first wheel hub step 120 and the first rear wheel 114 includes a second wheel hub step 124. Although not shown, the second front wheel 112 and the second rear wheel 116 can additionally include wheel hub steps.

As shown in FIG. 1, a person 130 is stepping on the second wheel hub step 124. The person has footwear 132 that comes into contact with a wall 140 of the second wheel hub step 124. The wall 140 of the example second wheel hub step 124 extends between a first end 142 and a second end 144. For example, the first end 142 is adjacent the wheel 114 and the second end 144 extends a distance 146 of at least 2.5 inches from the first end 142. In some examples, the extension distance 146 can be greater or less than 2.5 inches. An outer surface 148 of the wall includes a surface treatment 150. The surface treatment 150 increases friction between the footwear 132 and the outer surface 148 to prevent the footwear 132 from slipping off the wheel hub step 124. In some examples, the surface treatment 150 is grip tape, formed rubber, a non-slip coating, a textured finish, etc. Additionally or alternatively, the first wheel hub step 120 is substantially similar to the second wheel hub step 124.

The example first front wheel 110 includes a rotational axis 152. The example first wheel hub step 120 includes a central axis 154. The rotational axis 152 and the central axis 154 are coaxial. In the illustrated example, the wheel hub steps 120, 124 are radially-symmetric. In such examples, the wheel hub steps 120, 124 can be used at any angular position. Additionally, in the illustrated example, a height 156 of the wheel hub steps 120, 124 relative to the ground 158 does not change with respect to angular position of the wheel 110.

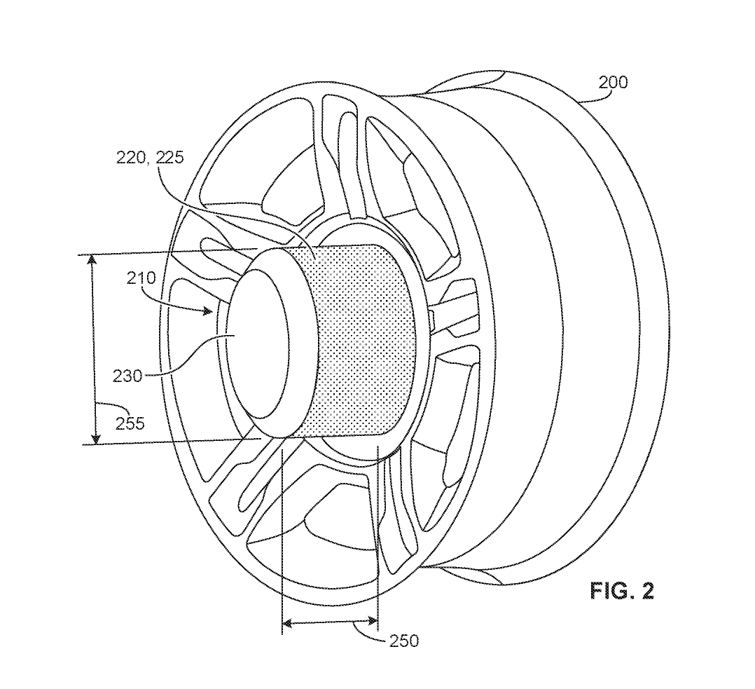

FIG. 2 illustrates an example wheel 200 including a wheel hub step 210 that is integral to the example wheel 200. The example wheel 200 can be any diameter or width. In some examples, the wheel 200 corresponds to the wheels 110, 112, 114, 116 of FIG. 1. In the illustrated example of FIG. 2, the wheel hub step 210 is integrally coupled to the wheel 200. A wall 220 of the example wheel hub step 210 additionally includes a surface treatment 225. In some examples, the wheel hub step 210 includes a cover 230. The cover 230 can protect fasteners that couple the wheel 200 to a vehicle.

The example wheel hub step has a depth 250 and a diameter 255. The depth 250 is large enough to properly function as a step, but not interfere with the function of the vehicle 100 of FIG. 1. For example, the depth 250 could be as little as approximately two and one-half inches or as large as approximately eight inches. Additionally, the diameter 255 is not so large as to make the wheel hub step 210 a non-ergonomic stepping height. Depending on the wheel size, the diameter 255 could range from approximately four to eight inches.

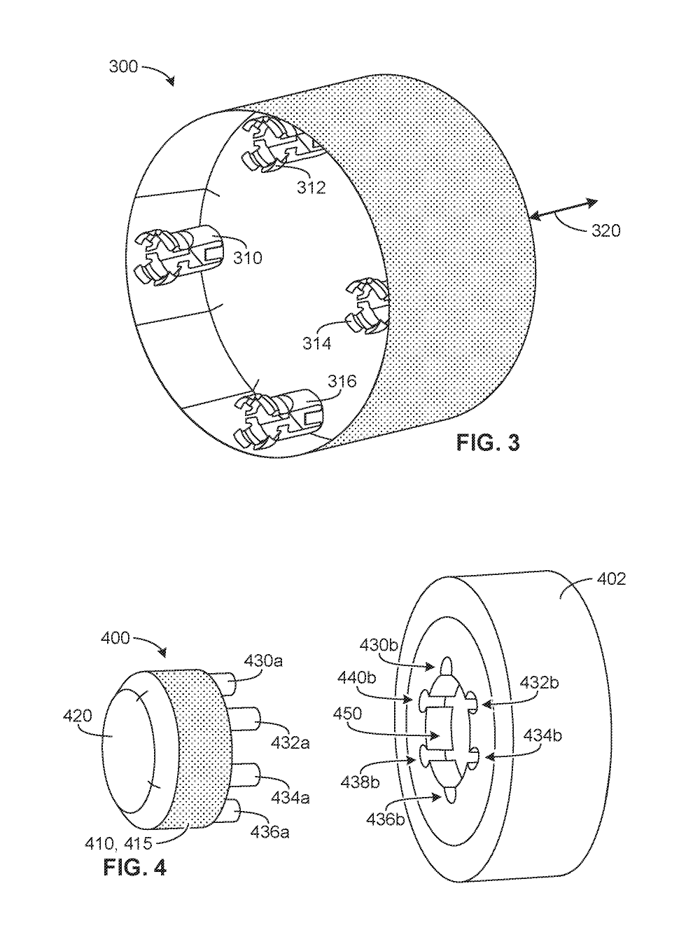

FIG. 3 illustrates an example wheel hub step 300 including snap-fit connectors 310, 312, 314, 316. In some examples, the wheel hub step 300 includes four, five, six, or eight snap-fit connectors. The snap-fit connectors 310, 312, 314, 316 are made to snap onto the fasteners coupling the wheels 110, 112, 114, 116 to the vehicle 100 of FIG. 1. In some examples, the fasteners coupling the first wheel 110 to the vehicle 100 are bolts or nuts. For example, the snap fit connectors 310, 312, 314, 316 are configured to couple to the bolts or nuts fastening the example wheels 110, 112, 114, 116 to the vehicle 100.

The snap fit connectors 310, 312, 314, 316 are spaced to match a spacing of fasteners coupling the wheels 110, 112, 114, 116 to the vehicle 100 of FIG. 1. For example, wheel fasteners are typically spaced 90° apart in a typical four fastener arrangement. Alternatively, fasteners are spaced 72° apart in a typical five fastener arrangement, 60° apart in a typical six fastener arrangement, and 45° apart in a typical eight fastener arrangement. Additionally, the fasteners are typically arranged in a circle having a diameter between 3 and 6 inches. In some examples, each wheel fastener has a corresponding snap-fit connector, matching the fastener arrangement of the wheels 110, 112, 114, 116. In other examples, only a subset of the wheel fasteners has a corresponding snap-fit connector.

In some examples, the snap-fit connectors 310, 312, 314, 316 are directional snaps. For example, the snap-fit connectors may only couple or decouple to the fasteners when pushed or pulled along one axis, such as an axis 320. In such examples, the snap-fit connectors 310, 312, 314, 316 do not decouple when a force is applied to the wheel hub step 300 in a direction perpendicular to the axis 320 (e.g., when the wheel hub step supports the weight of a person). In some examples, the wheel hub step 300 can be decoupled and coupled to any of the wheels 110, 112, 114, 116 by hand by a person.

FIG. 4 illustrates an example wheel hub step 400 including hub connectors. The example wheel hub step 400 couples to a wheel 402 corresponding to any of the wheels 110, 112, 114, 116 of FIG. 1. Additionally, the illustrated wheel hub step 400 of FIG. 4 includes a solid wall 410 having a surface treatment 415 and a cover 420. For example, the example cover 420 is on a second end 144 of the wheel hub step 400 opposite a first end 142 that couples to the wheel 402.

The wheel hub step 400 of FIG. 4 includes a protrusion 430a and the wheel 402 includes a complementary aperture 430b. In some examples, the protrusion 430a is a quick disconnect, a key, a push button quick release pin, or a protrusion forming a slip-fit with the complementary aperture 430b. Additionally or alternatively, the protrusion 430a can include a locking mechanism to prevent removal of the wheel hub step 400. As illustrated in FIG. 4, additional protrusions 432a, 434a, 436a, also have corresponding complementary apertures 432b, 434b, 436b. Additionally, complementary apertures 438b and 440b correspond to protrusions not shown in FIG. 4. The example protrusions 432a, 434a, 436a are similar to the protrusion 430a, and the complementary apertures 432b, 434b, 436b, 438b, 440b are similar to the complementary aperture 430b.

The example wheel 402 also includes an aperture 450 that is surrounded by the complementary apertures 430b, 432b, 434b, 436b, 438b, 440b. In some examples, the fasteners that couple the wheel 402 to the vehicle 100 of FIG. 1 are disposed in the aperture 450, while in other examples, the fasteners could be disposed in the complementary apertures 430b, 432b, 434b, 436b, 438b, 440b.

FIG. 5 illustrates an example wheel 500 and an example wheel hub step 510 having a radially-symmetric body 520 having a cylindrical shape 525. In certain examples disclosed herein, the wheel hub step 510 is concentric with the wheel 500. In such examples, the wheel hub step 510 can be used at any angular position. Additionally, the cylindrical shape 525 inhibits the accumulation of water, snow, mud, or other detritus on the wheel hub step 510. The example wheel hub step 510 could correspond to any one of the wheel hub steps 120, 124, the wheel hub step 210 of FIG. 2, the wheel hub step 300 of FIG. 3, or the wheel hub step 400 of FIG. 4.

In some examples, the wheel hub step 510 can include a cover 530 to protect a set of fasteners 540 from outside weather conditions. Additionally or alternatively, the example wheel 500 includes the set of fasteners 540 that additionally couple the wheel hub step 510 to the wheel 500. In the illustrated example, the fasteners 540 are disposed underneath the cover 530 and are represented via dashed lines. For example, the fasteners 540 may be nuts that couple the wheel 500 to the example vehicle 100 of FIG. 1, via studs on the vehicle 100, additionally couple the wheel hub step 510 to the wheel 500.

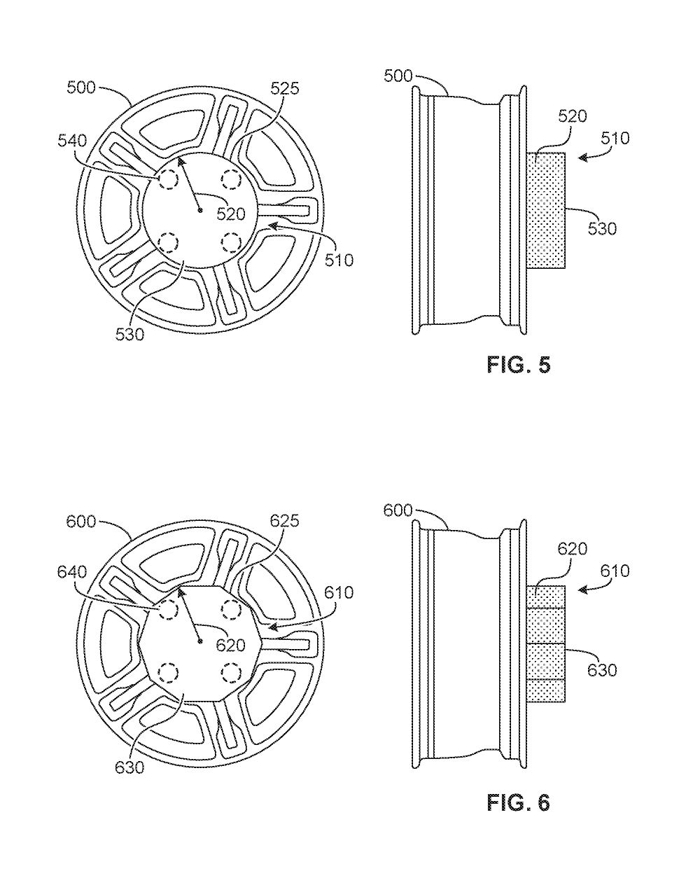

FIG. 6 illustrates an example wheel 600 and an example wheel hub step 610 having a radially-symmetric body 620 having a polygonal shape 625. In certain examples disclosed herein, the wheel hub step 610 is concentric with the wheel 600. In such examples, the wheel hub step 610 can be used at any angular position. In the illustrated example, the polygonal shape 625 is a decagon. In other examples, the polygonal shape 625 could be hexagonal, rectangular, pentadecagonal, or any other polygonal shape. In some examples, the polygonal shape 625 can provide a more stable step than a cylindrical shape. The example wheel hub step 610 could correspond to any one of the wheel hub steps 120, 124, the wheel hub step 210 of FIG. 2, the wheel hub step 300 of FIG. 3, or the wheel hub step 400 of FIG. 4.

In some examples, the wheel hub step 610 can include a cover 630 to protect a set of fasteners 640 from outside weather conditions. Additionally or alternatively, the example wheel 600 includes the set of fasteners 640 that additionally couple the wheel hub step 610 to the wheel 600. For example, the fasteners 640 may be nuts that couple the wheel 600 to the example vehicle 100 of FIG. 1, via studs on the vehicle 100, additionally couple the wheel hub step 610 to the wheel 600.

From the foregoing, it will be appreciated that example apparatus have been disclosed that provide a wheel hub step for improved access to vehicle engine compartments, roofs, and truck beds. In some examples, the wheel hub step includes a surface treatment to prevent slippage between footwear and the wheel hub step, providing a safe step to access difficult-to-reach areas of a vehicle. Additionally, the wheel hub step provides access to areas of the vehicle that running boards or side-box steps could not otherwise provide. Additionally, the height of the wheel hub step is at an ergonomic height, for improved user access.

Although certain example apparatus and articles of manufacture have been disclosed herein, the scope of coverage of this patent is not limited thereto. On the contrary, this patent covers all methods, apparatus and articles of manufacture fairly falling within the scope of the claims of this patent.

1. A wheel hub step comprising:
a radially-symmetric body having a first end to be adjacent a vehicle wheel and a second end opposite the first end, the radially-symmetric body removably coupled to the vehicle wheel via fasteners that couple the vehicle wheel to a vehicle; and
a wall extending between the ends and approximately coaxial relative to a rotational axis of the vehicle wheel, the wall having an outer surface including a surface treatment to increase friction between footwear and the wheel hub step.

2. (canceled)

3. (canceled)

4. (canceled)

5. The wheel hub step of claim 1, wherein the radially-symmetric body is removably coupled to the vehicle wheel via a snap-fit connector.

6. The wheel hub step of claim 1, wherein the rotational axis of the vehicle wheel and a central axis of the radially-symmetric body are coaxial when the radially-symmetric body is coupled to the vehicle wheel.

7. A wheel hub step comprising:
means for stepping including an outer surface, the outer surface including a surface treatment to increase friction between footwear and the wheel hub step; and
means for coupling the means for stepping to a vehicle wheel, the means for coupling including a snap-fit connector to couple the means for stepping to the vehicle wheel via fasteners that couple the vehicle wheel to a vehicle.

8. The wheel hub step of claim 7, wherein a rotational axis of the vehicle wheel and a central axis of the means for stepping are coaxial when the means for stepping is coupled to the vehicle wheel.

9. The wheel hub step of claim 8, wherein the means for stepping can be used at any angular position.

10. (canceled)

11. (canceled)

12. The wheel hub step of claim 7, wherein the means for stepping is configured to support a person when the means for stepping is coupled to the vehicle wheel.

13. The wheel hub step of claim 7, wherein the surface treatment includes a textured finish.

14. An apparatus comprising:
a radially-symmetric wheel hub step extending from a vehicle wheel, wherein the wheel hub step extends approximately coaxial relative to a rotational axis of the vehicle wheel and includes a solid, textured surface, the radially-symmetric wheel hub step removably coupled to the vehicle wheel via fasteners that couple the vehicle wheel to a vehicle.

15. The apparatus of claim 14, wherein the wheel hub step can support a person.

16. The apparatus of claim 14, wherein the wheel hub step has a central axis, and wherein the rotational axis of the vehicle wheel and the central axis are coaxial.

17. The apparatus of claim 14, wherein the wheel hub step is polygonal.

18. The apparatus of claim 17, wherein the wheel hub step extends more than 2.5 inches from a hub of the vehicle wheel.

19. The apparatus of claim 14, further including an aperture in the wheel hub step to receive a fastener, wherein the fastener couples the vehicle wheel to the vehicle.

20. The apparatus of claim 19, further including a cover to enclose the aperture.

21. The wheel hub step of claim 1, further including a cover disposed at the second end of the radially-symmetric body.

22. The wheel hub step of claim 1, wherein the radially-symmetric body has a polygonal shape.

23. The wheel hub step of claim 7, wherein the means for stepping has a polygonal shape.

24. The apparatus of claim 14, wherein the radially-symmetric wheel hub step is removably coupled to the vehicle wheel via a snap-fit connector.

25. The apparatus of claim 14, wherein the radially-symmetric wheel hub step can be used at any angular position.
